(19) United States
(12) Patent Application Publication
(10) Pub. No.: US 2007/0021782 A1
(43) Pub. Date: Jan. 25, 2007

(54) Nipple device

(76) Inventors: Masaharu Inoue, Saitama-Ken (JP); Nobuaki Takamizu, Saitama-Ken (JP); Tatsuhiko Kan, Saitama-Ken (JP); Wakoto Bukawa, Saitama-Ken (JP); Takumi Watanabe, Saitama-Ken (JP)

Correspondence Address: BIRCH STEWART KOLASCH & BIRCH, PO BOX 747, FALLS CHURCH, VA, 22040-0747, US

(21) Appl. No.: 10/557,734

(22) PCT Filed: Apr. 20, 2004
(86) PCT No.: PCT/JP04/05628

§ 371 Date: Nov. 21, 2005

(51) Int. Cl. A61J 17/00

(52) U.S. Cl. 606/234

(57) ABSTRACT

A nipple apparatus 10 comprises a nipple 11, and a nipple holding member 15 for holding the nipple 11. A liquid permeating member 25 is provided in the nipple holding member 15, and cap 17 is also provided at the nipple holding member 15. In the cap 17, a drug container 20 covered with a film 21 is housed. Upon engagement of the cap 17 with the nipple holding member 15, a projection 19 at the nipple holding member 15 sticks the film 21.

### FIELD OF THE INVENTION

The present invention relates to a nipple apparatus which can administrate drugs to babies.

### BACKGROUND OF THE INVENTION

In the past, comforters filled with drugs have been known as means for administrating drugs to babies while allowing them to enjoy the articles in their mouths (See, for example, TOKUHYOU No. 2001-511644).

A comforter has a mouthpiece with vacancies in which a tablet(s) is disposed. While a baby is enjoying such a comforter in its mouth, the tablet is administered on a time-release basis to the baby.

In the comforter described above where the tablet is disposed in the vacancy of the mouthpiece, upon supplementing the tablet to the comforter, the tablet must be necessarily positioned in the vacancy of the mouthpiece, which makes the supplementary work cumbersome or complex.

Although the comforter should be washed regularly, it is not possible to wash the comforter selectively because it is combined with a container into a single unit.

### SUMMARY OF THE INVENTION

The present invention was made in the light of the above problems, and hence it is an object of this invention to provide a nipple apparatus for enabling to perform the drug supplement and washing with ease.

The present invention is a nipple apparatus comprising a nipple, a nipple holding member for holding the nipple, and a cap for engaging with the nipple holding member; wherein a drug container portion in which a drug is filled and which is covered with a film on its nipple side, is provided in the cap, and wherein a cutting portion for cutting the film when the cap engages with the nipple holding member is provided at the nipple holding member.

The present invention is a nipple apparatus, wherein a liquid permeating member extending into the nipple is provided at the nipple holding member, and the cutting portion comprises a projection for sticking the film.

The present invention is a nipple apparatus, wherein an external thread is formed in the nipple holding member and an internal thread for engaging with the external thread is formed in the cap.

The present invention is a nipple apparatus, wherein the liquid permeating member comprises a plate-like member for abutting with the film of the drug container portion and a rod-like member extending from the plate-like member toward the nipple.

The present invention is a nipple apparatus, wherein an opening is provided in the plate-like member of the liquid permeating member, and the projection projects from the nipple through the opening toward the drug container portion.

The present invention is a nipple apparatus, wherein the drug container portion comprises a drug container which is provided in the cap.

The present invention is a nipple apparatus, wherein the drug container portion comprises an area divided by the film in the cap.

The present invention is a nipple apparatus, wherein the nipple holding member has a communicating space in communication with the nipple, the communicating space being covered with a compartment wall which is provided on the side of the drug container portion and has a communicating port.

The present invention is a nipple apparatus, wherein the cutting portion of the nipple holding member comprises an edge portion of the compartment wall.

The present invention is a nipple apparatus comprising a one-way valve in the opening of the compartment wall for introducing the drug from the drug container portion to the needle holding member.

The present invention is a nipple apparatus comprising a nipple, a nipple holding member having a container housing portion communicating with the nipple, for holing the nipple, a cap attached swayably to the needle holding member and covering the container housing portion, wherein a drug container in which a drug is filled, having an opening on the side of the nipple is provided in the container housing portion.

The present invention is a nipple apparatus, wherein a cylindrical guide projecting toward the nipple is provided in the container housing portion, and the drug container has a spout inserted in the cylindrical guide.

The present invention is a nipple apparatus, wherein the drug container is removable from the container housing portion, and an engagement rib for engaging with the cylindrical guide of the container housing portion is provided in the cap.

The present invention is a nipple apparatus, wherein the drug container is formed of a flexible material and fixed in the container housing portion, and a pressing portion for crushing the drug container is provided in the cap.

The present invention is a nipple apparatus, wherein the drug is xylitol.

The present invention is a nipple apparatus, wherein the drug comprises a virus capturing composition.

The present invention is a nipple apparatus, wherein the virus capturing composition contains a water extract of swallow nests and/or an enzymatically-treated substance of swallow nests as an effective ingredient.

### BRIEF DESCRIPTION OF THE DRAWINGS

FIG. 1 is a side cross-sectional view showing a first embodiment of a nipple apparatus according to the present invention.

FIG. 2 is an exploded view of a nipple apparatus.

FIG. 3 is a view taken along line III of FIG. 1.

FIG. 4 is a side-cross sectional view showing a second embodiment of a nipple apparatus according to the present invention.

FIG. 5 is an exploded view of a nipple apparatus.

FIG. 6 is a perspective view of a third embodiment of a nipple apparatus according to the present invention.

FIG. 7 is a partly cross-sectional view of a nipple apparatus.

FIG. 8 is a view showing a variation of the nipple apparatus according to the present invention.

FIG. 9 is a view showing a variation of the nipple apparatus according to the present invention.

FIG. 10 is a chart showing results from investigating the infection-neutralizing activities of influenza viruses for a virus capturing composition.

FIG. 11 is a chart showing results from investigating molecular pieces of sialic acids contained in the virus capturing composition and their contents.

FIG. 12 is a chart showing results from investigating affinity of glycopeptides contained in the virus capturing composition to influenza viruses after isolation of the glycopeptides with SDS-PAGE.

### THE BEST MODE FOR CARRYING OUT THE INVENTION

Hereinafter, embodiments of the present invention will be described with reference to the drawings.

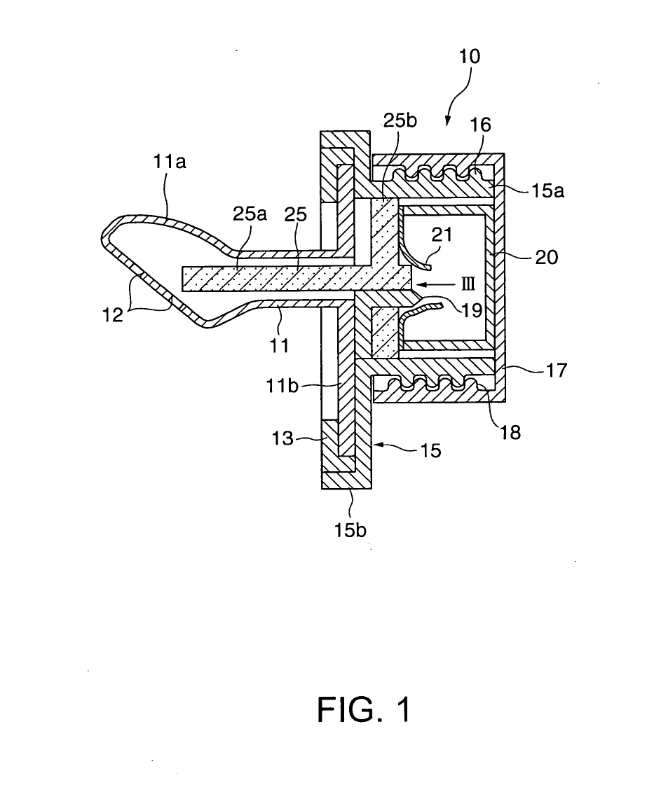

FIGS. 1 to 3 illustrate a first embodiment of a nipple apparatus according to the present invention. Among these drawings, FIG. 3 is a view taken along line III of FIG. 1.

As shown in FIGS. 1 to 3, a nipple apparatus 10 comprises a nipple 11 to be put in a mouth of a baby, a nipple holding member 15 for holding the nipple 11, a liquid permeating member 25 extending from the nipple holding member 15 into the nipple 11, and a cap 17 engaging with the nipple holding member 15.

In the cap 17 drug container (drug container portion) 20 is provided, which is filled with a liquid-state drug containing, for example, a xylitol ingredient for preventing dental caries. A surface on the side of nipple 11 of the drug container 20 is covered with a film 21 formed of a silver foil or resin. A projection 19 for sticking the film 21 of the drug container 20 when the cap 17 engages with the nipple holding member 15, is provided in the needle holding member 15. The projection 19 serves as a cutting portion for cutting the film 21 when the cap 17 engages with the needle holding member 15.

Next, components for constructing each portion will be described in more detail. The nipple 11 has a cylindrical nipple body 11a and a plate-like proximal portion 11b provided at a proximal end of the nipple body 11a. In the nipple body 11a, an opening 12 is provided for supplying outward a drug which has been directed through the liquid permeating member 25.

The nipple holding member 15 has a cylindrical portion 15a, and a larger diameter portion 15b having a diameter lager than that of the cylindrical portion 15a. The proximal portion 11b of the nipple 11 is inserted in the larger diameter portion 15b of the nipple holding member 15, and a holding frame 13 is further fitted in the larger diameter portion 15b from the outside of the proximal portion 11b. In such a manner, the nipple 11 is held by the nipple holding member 15.

The drug container 20 is so constructed that it is inserted in the cylindrical portion 15a of the nipple holding member 15, and the drug container 20 is fixed to the cap 17.

The nipple side surface of the drug container 20 is covered by the film 21 as mentioned above, and the film 21 is stuck and broken with ease by the projection 19 of the nipple holding member 15.

The liquid permeating member 25 has a disk-shaped and plate-like member 25b for abutting with the film 21 of the drug container 20, which is of the same shape as the film 21, and a rod-like member 25a extending from the plate-like member 25b toward the nipple 11. The liquid permeating member 25 is made entirely of a sponge material and transmits a drug contained in the drug container 20 toward the nipple 11.

In the plate-like member 25b of the liquid permeating member 25, an opening 26 is formed, locating below the rod-like member 25a. By inserting the projection 19 of the nipple holding member 15 through the opening 26 of the plate-like member 25b, the liquid permeating member 25 can be positioned and fixed with respect to the nipple holding member 15.

The rod-like member 25a of the liquid permeating member 25 is preferably of the same outer surface shape as the inner surface shape of the nipple body 11a of the nipple 11: In such a case, the liquid permeating member 25 can be positioned and fixed by the nipple body 11a.

The projection 19 of the nipple holding member 15 is positioned between the cylindrical portion 15a and the larger diameter portion 15b, and has a pointed distal end on the side of the film 21 of the drug container 20.

An external thread 16 is formed in the outer surface of the cylindrical portion 15a of the nipple holding member 15, while an internal thread 18 for engaging with the external thread 16 is provided in the inner surface of the cap 17. Rather than the thread engagement, the cylindrical portion 15a and the cap 17 may engage with each other in a one-touch fitting manner.

In either case, the cylindrical portion 15a of the nipple holding member 15 and the cap 17 should be engaged in a hermetically sealed state.

Next, an operation of the so-constructed embodiment is described.

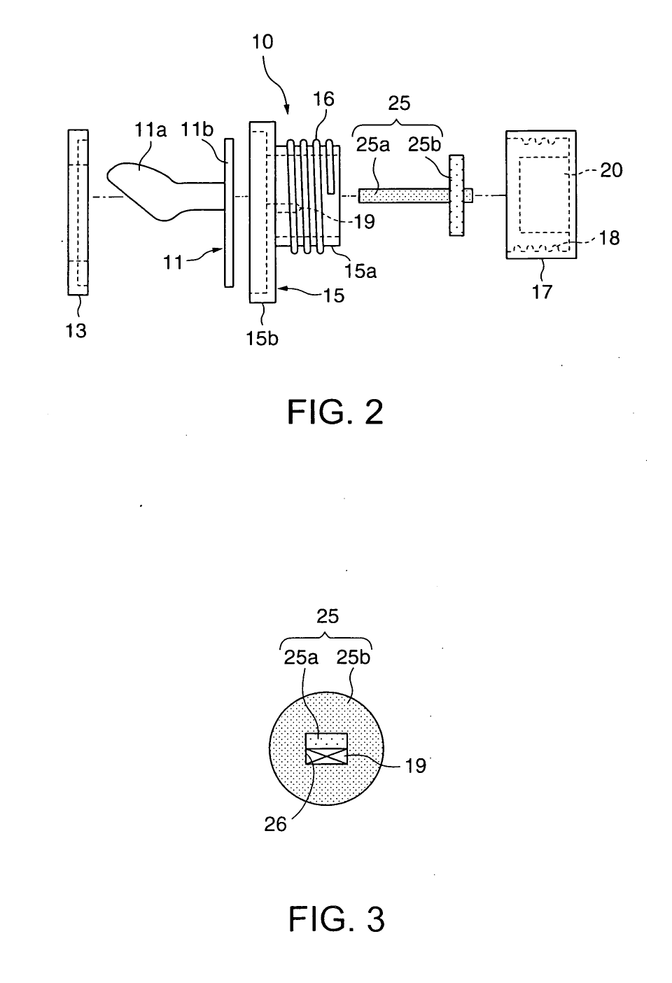

First, as shown in FIG. 2, the projection 19 of the nipple holding member 15 is inserted in the opening 26 of the plate-like member 25b of the liquid permeating member 25.

The proximal portion 11b of the nipple 11 is then fitted in the larger diameter portion 15b of the nipple holding member 15, and the holding frame 13 is in turn fitted in the larger diameter portion 15b thereby to hold the nipple 11 by using the nipple holding member 15.

In this case, it is preferable that a sealing material is located between the larger diameter portion 15b of the nipple holding member 15 and the holding frame 13. By inserting the projection 19 of the nipple holding member 15 in the opening 26 of the liquid permeating member 25 and by causing the rod-like member 25a of the liquid permeating member 25 to abut with the inner surface of the nipple body 11a, the liquid permeating member 25 is positioned and fixed by the nipple holding member 15 and the nipple 11.

Subsequently, the external thread 16 of the nipple holding member 15 and the internal thread 18 of the cap 17 engage with each other, and the cap 17 is fitted around the cylindrical portion 15a of the nipple holding member 15. In this case, the drug container 20 is already attached to the inner surface of the cap 17, and upon fitting the cap 17 around the cylindrical portion 15a of the nipple holding member 15, the film 21 of the drug container 20 is stuck and broken by the projection 19 of the nipple holding member 15.

Upon breakage of the film 21, a liquid-state drug (including a xylitol ingredient) in the drug container 20 travels through the liquid permeating member 25 toward the nipple 11.

When the nipple 11 is put in a mouth of a baby, the drug having traveled toward the nipple 11 through the liquid permeating member 25 is then directed from the opening 12 of the nipple body 11a into the mouth of the baby, thereby performing the prevention of dental caries utilizing the xylitol ingredient.

It should be noted that when all drug in the drug container 20 is consumed, the cap 17 and drug container 20 can be removed from the nipple holding member 15, and a new cap 17 having a pre-loaded drug container 20 can be attached to that nipple holding member 15.

In addition, after using the nipple apparatus 10 for a long-period of time, each component can be disassembled in a reverse manner to the above described procedure so as to wash it separately (See FIG. 2).

Thus, according to the embodiment described above, when the drug contained in the drug container 20 is consumed, easy and simple drug supplement can be carried out only by attaching new drug container 20 and cap 17 to the nipple holding member 15. Additionally, each of the components can be washed with ease only by disassembling the individual component.

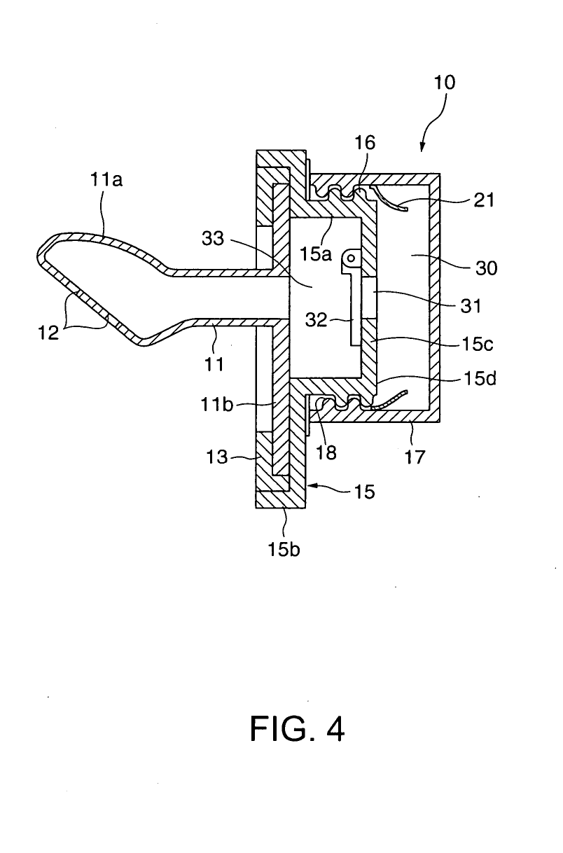

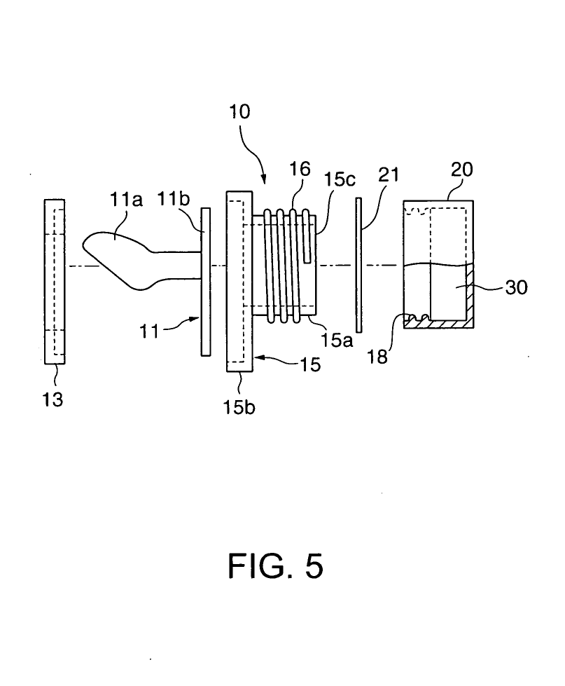

Next, a second embodiment of the nipple apparatus according to the present invention will be described with reference to FIGS. 4 and 5. In the second embodiment illustrated in FIGS. 4 and 5, like parts to those of the first embodiment shown in FIGS. 1 to 3 are denoted by like numerals, and thus their detailed descriptions are omitted.

As shown in FIGS. 4 and 5, a nipple apparatus 10 comprises a nipple 11 to be put in a mouth of a baby, a nipple holding member 15 for holding the nipple 11, and a cap 17 engaging with the nipple holding member 15.

A film 21 is provided in the cap 17. In an area 30 formed by dividing the internal space of the cap 17 by the film 21 is filled a liquid-state drug, for example, a liquid-state drug containing a xylitol ingredient for preventing dental caries. Thus, the area 30 formed by the film 21 in the cap 17 constitutes a drug containing portion.

Upon the engagement of the cap 17 with the nipple holding member 15, an edge portion (cutting portion) 15d of a compartment wall 15c which will be described below cuts and breaks the film 21.

The nipple holding member 15 includes a cylindrical portion 15a and a larger diameter portion 15b provided at one end of the cylindrical portion 15a, and the compartment wall 15c is provided at the other end of the cylindrical portion 15a.

The nipple holding member 15, which is constructed as described above, has a communicating space 33 therein in communication with the interior of the nipple 11, and the space 33 is covered with the compartment wall 15c. In addition, a communicating port 31 is formed in the compartment wall 15c, and an one-way valve 32 is attached to the surface on the side of the communicating space 33 of the compartment wall 15c for sealing the communicating port 31 so as to enable it to freely open and close. The one-way valve 32 operates to introduce a drug in the area 30 into the communicating space 33, while it prevents the transfer of the drug from the communicating space 33 to the area 30.

Next, an operation of the embodiment having the above construction is described.

First, as shown in FIG. 4, the proximal portion 11b of the nipple 11 is fitted in the larger diameter portion 15b of the nipple holding member 15, and the holding frame 13 is then fitted in the larger diameter portion 15b thereby to hold the nipple 11 by using the nipple holding member 15.

An internal thread 18 of the cap 17 engages with an external thread 16 of the nipple holding member 15, and the cap 17 is fitted around the cylindrical portion 15a of the nipple holding member 15. In this case, a drug is already filled in the area 30 divided by the film 21 in the cap 17, and when the cap 17 is fitted around the cylindrical portion 15a of the nipple holding member 15, the film 21 in the cap 17 is cut by the edge portion 15d of the compartment wall 15c of the nipple holding member 15.

When the film 21 is cut, the drug in the area 30 flows into the communicating space 33 of the nipple holding member 15 through the communicating port 31 and one-way valve 32, then the drug in the communicating space 33 travels toward the nipple 11.

When the nipple 11 is put in a mouth of a baby, the drug having traveled toward the nipple 11 is then directed from the opening 12 into the mouth of the baby, thereby enabling to prevent dental caries utilizing the xylitol ingredient.

It should be noted that when all drug in the area 30 of the cap 17 is consumed, the cap 17 can be removed from the nipple holding member 15, and a new cap 17 can be attached to the nipple holding member 15.

In addition, after using the nipple apparatus 10 for a long-period of time, each component can be disassembled in a reverse manner to the above described procedure so as to wash it individually (See FIG. 5).

As stated above, according to the present invention, if the drug is consumed, the supplement work can be carried out with ease and simplicity, as well as each component can be disassembled for easy washing.

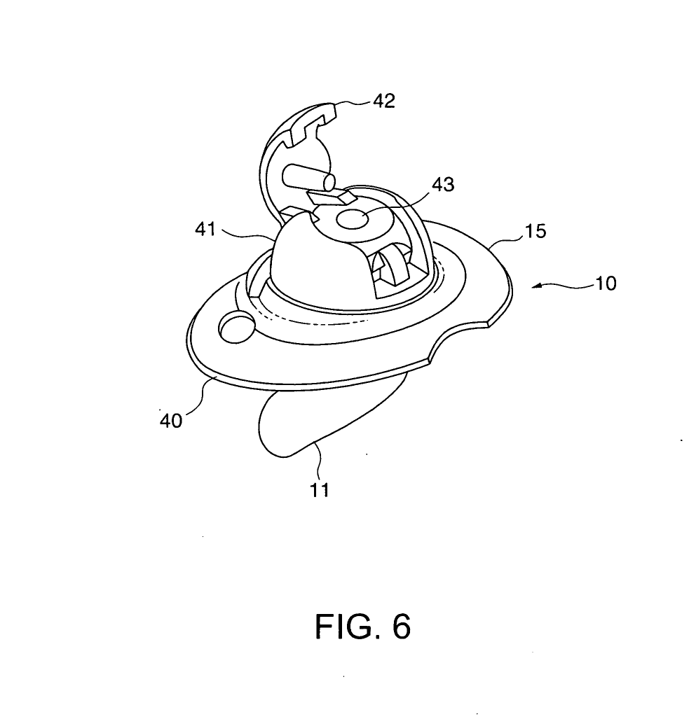

A third embodiment of the nipple apparatus according to the present invention will be described with reference to FIGS. 6 to 9.

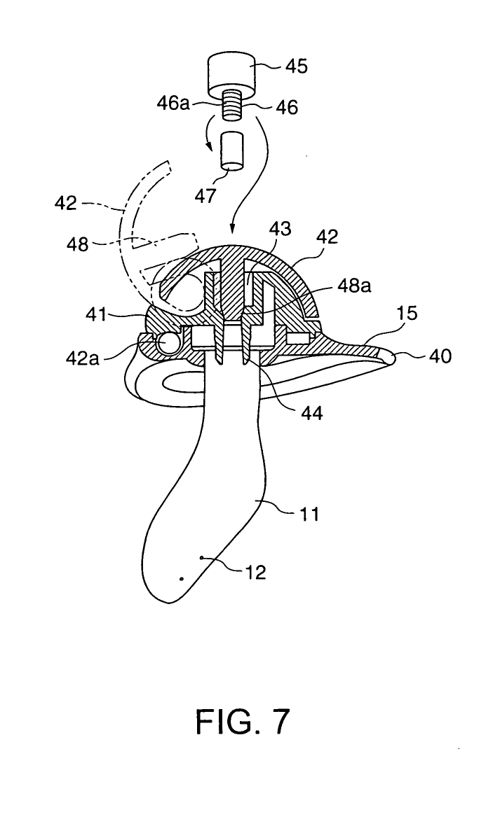

As shown in FIGS. 6 and 7, a nipple apparatus 10 comprises nipple 11 which is put in a mouth of a baby, nipple holding member 15 holding the nipple 11 and having container housing portion 43 in communication with the nipple 11, and cap 42 attached swayably to the container holding member 15 and covering the container housing portion 43.

The nipple is of a hollow shape, and is configured to store a liquid state drug, for example, a drug containing a xylitol ingredient for preventing dental caries, which is delivered into and fills drug container 45, as described below. Also in the nipple 11 is provided an opening 12 for supplying the drug stored in the interior outward.

The nipple holding member 15 includes flange 40 for holding the nipple 11, and flange cover 41 provided on the flange 40, and the container housing portion 43 is disposed in the flange cover 41.

The container housing portion 43 provided in the flange cover 41, is open at its upper portion, and a drug container 45 containing a liquid state drug is housed in the container housing portion 43. Also in the container housing portion 43 is provided cylindrical guide 44 for projecting toward the nipple 11, where the container housing portion 43 is in communication with the nipple 11 through the cylindrical guide 44.

The cap 42 is attached swayably to the flange cover 41 of the nipple holding member 15 through a pivot shaft 42a and is configured to cover the container housing portion 43 from above. In addition, an engagement rib 48 for engaging with an upper end of the cylindrical guide 44 is attached to an inner surface of the cap 42. When the cap 42 covers the container housing portion 43, the engagement rib 48 is inserted in the container housing portion 43 and engages with the upper end of the cylindrical guide 44.

In this case, the upper end of the cylindrical guide 44 has a tapered shape becoming narrower as one moves downward, and distal portion 48a of the engagement rib 48 is also of a tapered shape becoming narrower downward corresponding to the upper end of the cylindrical guide 44. The engagement rib 48 is preferably formed of a flexible material.

A drug in a liquid state is filled in the interior of the drug container 45, and it is housed in the container housing portion 43. The drug container 45 is formed of a flexible material, and has a container body 45a for containing the drug, and a spout 46 formed of a hard material and disposed at a lower portion of the container body 45a. The spout 46 of the drug container 45 has an external thread 46a formed in its outer surface, and the spout 46 is inserted and fixed in the cylindrical guide 44 of the nipple holding member 15 by screwing the external thread 46a into an internal thread of the cylindrical guide 44 (not shown).

It should be noted that the spout 46 may be fitted in the cylindrical guide 44 without forming the external thread on the outer surface of the spout 46.

In FIGS. 6 and 7, when in use, a cover 47 screwed into the spout 46 of the drug container 45 is first removed, and the external 46a of the spout 46 of the drug container 45 is then screwed into the internal thread of the cylindrical guide 45. In this case, by screwing the external thread 46a of the spout 46 of the drug container 45, into the internal thread of the cylindrical guide 45, the drug container 45 can be fixed firmly in the container housing portion 43.

Subsequently, the container body 45a formed of a flexible material of the drug container 45 is urged to be pressed downwardly from the above to supply the drug contained in the container body 45a into the nipple 11 through the spout 46 and cylindrical guide 44. The drug container 45 is then removed from the container housing portion 43, and the cap 42 pivots about the pivot shaft 42a to close the container housing portion 43 with the cap 42. At this point, the engagement rib 48 provided on the inner surface of the cap 42 engages with the upper end of the cylindrical guide 44 to seal securely the upper end of the cylindrical guide 44.

Since the engagement rib 48 is formed entirely of a flexible material, it can be assured that the upper end of the cylindrical guide 44 is sealed hermetically by the distal portion 48a of the engagement rib 48.

When the nipple 11 is put in a mouth of a baby, the drug in the nipple 11 travels from the opening 12 into the mouth of the baby, thus enabling to prevent dental caries utilizing the xylitol ingredient.

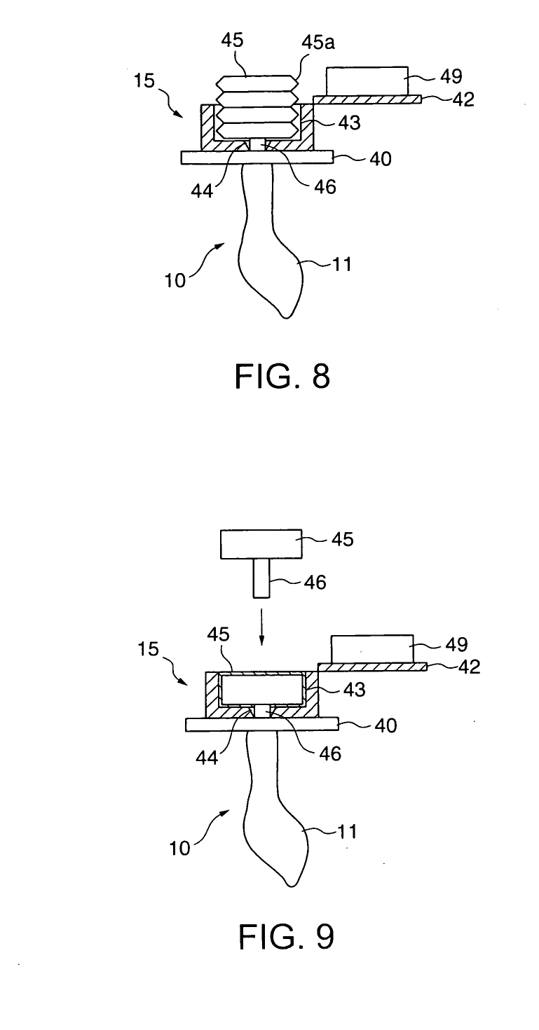

Referring now to FIGS. 8 and 9, a variation of the embodiment shown in FIGS. 6 and 7 is described. In this embodiment illustrated in FIGS. 8 and 9, a drug container 45 is fixed to container housing portion 43.

In FIGS. 8 and 9, like parts to those of the embodiment shown in FIGS. 6 and 7 are denoted by like numerals, and thus their detailed descriptions are omitted.

As depicted in FIG. 8, the drug container 45 includes a container body 45a containing a drug and formed of a bellows-like flexible material, and a spout 46 provided at a lower end of the container body 45.

Nipple holding member 15 for holding the nipple 11 has a flange 40 and a container housing member 43 provided on the flange 40.

The container housing portion 43 is configured to house the drug container 45 therein, and cylindrical guide 44 to be narrower toward the nipple 11 is provided under the container housing portion 43.

The container housing portion 43 is open at its upper portion, and cap 42 for covering the housing portion 43 is pivotally attached thereto. A pressing portion 49 for pressing the bellows-like container body 45a is provided on the inner surface of the cap 42.

In FIG. 8, the drug container 45 is housed in the container housing portion 43 of the nipple holding member 15, while the spout 46 of the drug container 45 is inserted into the cylindrical guide 44.

In this case, with an external thread formed in the outer surface of the spout 46 of the drug container 45 and with an internal thread formed in the inner surface of the cylindrical guide 44, the spout 46 can be fixed into the cylindrical guide 44 to securely fix the drug container 45 in the container housing portion 43.

Next, the cap 42 pivots to cover the container housing portion 43 therewith. Thus, the container body 45a of the drug container 45 is pressed by the pressing portion 49 of the cap 42, and the drug contained in the container body 45a is directed toward the nipple 11 through the outlet port 46 and cylindrical guide 44.

A further variation of this invention is now discussed with referent to FIG. 9. In the variation illustrated in FIG. 9, a drug container 45 includes a container body 45a filled with a drug and a spout 46 provided at a lower end of the container body 45a. In this case, the container body 45a does not have a bellows-like configuration, but has a shallow chamber-like shape, and is formed of a flexible material.

In FIG. 9, the drug container 45 is housed in container housing portion 43 of nipple holding member 15. Again, with an external thread formed in the outlet port 46 of the drug container 45 and with an internal thread formed in the cylindrical guide 44, the spout 46 may be screwed into the cylindrical guide 44.

Subsequently, the cap 42 pivots to cover the container housing portion 43 therewith, causing the pressing portion 49 to press the container body 45a of the drug container 45. Thus, the drug in the container body 45 can be directed toward the nipple 11 through the outlet port 46 and cylindrical guide 44.

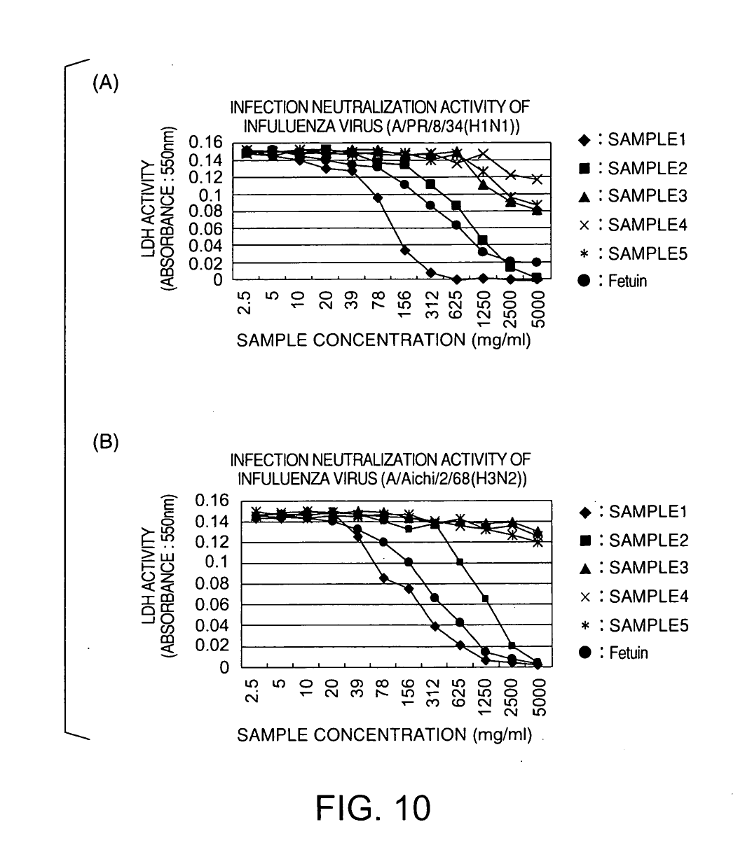

Next, a forth embodiment of the nipple apparatus according to the present invention is described with reference to FIGS. 10 to 12.

The embodiment illustrated in FIGS. 10 to 12 is different only in the point of using a virus capturing composition in place of the drug containing a xylitol ingredient as a liquid state drug, but it is substantially the same as the embodiments illustrated in FIGS. 1 to 9 in the other features.

In other words, the drug container 30 shown in FIGS. 1 to 3 is filled with a drug containing a virus capturing composition in place of a xylitol ingredient, and the area 30 of the cap 17 shown in FIGS. 4 and 5 is filled with a drug containing a virus capturing composition in place of a xylitol ingredient. Similarly, the drug container illustrated in FIGS. 6 to 9 is filled with a drug containing a virus capturing composition in place of a xylitol ingredient.

The virus capturing composition will be described below. This virus capturing composition contains a water extract of swallow nests and/or an enzymatically-treated substance of swallow nests as an effective ingredient.

The swallow nest is a nest fabricated by cave swallows using their saliva formed in a thread-like material. In China, the nest has been utilized as a high class food material from old times, and also used as a food providing various medical effects, such as healing of the pulmonary disease, enhancement of the stomach activity, expectorant effect, skin rejuvenation, nutrient and sthenia. Ingredients of this material include proteins and carbohydrates, but little lipids.

The swallow nests that are commercially available include those harvested in natural caves (cave nests) and those cultured in the interior (house nests), and both of them can be used. These materials are of various types including those produced only by removing dirt, such as feather and droppings, from the swallow nests and washing them, and those made by collecting debris of the swallow nest, repeating bleach and wash, and shaping the treated materials. It is preferred, however, to use swallow nests not subjected to excessive wash and bleach in their pretreatment.

For example, the water extract of swallow nests used in the present invention can be obtained in the following procedure. To the swallow nest ground to a particle diameter less than 2 mm, preferably less than 150 μm, water of 10 to 1,000 times the mass of the particles is added, leaving the admixture to stand at 1 to 100° C. for 0.5 to 48 hours or extracting it with stirring, then obtaining a filtrate by filtration. The filtrate can be used, directly or otherwise properly concentrated into a concentrate, as the virus capturing composition to be used in the present invention. Alternatively, these materials can be freeze-dried or spray-dried.

The enzymatically-treated substance of swallow nests can be obtained by preparing an extract liquid (pre-filtered solution) by adding to the swallow nest ground to the same particle size as described above water or hot water of 10 to 1,000 times the mass of the particles and extracting the admixture in the same manner as above, and thereafter subjecting the so-obtained extract liquid, a filtrate obtained by filtration of the extract liquid or a solution obtained by heating the extract liquid at 60 to 130° C. for 5 to 30 minutes to an enzymatic process.

The enzyme is preferably protease, and generally, those commercially marketed as enzymes for foods can be used in combination of one or two types or more of them. Specifically, examples of these enzymes can include “Pancreatine F” (trade name, produced by Amano Seiyaku Co., Ltd.), “Aloaze AP-10” (trade name, produced by Yakult Yakuhin Kogyo Co. Ltd.), “Papain Soluble” (trade name, produced by Yakult Yakuhin Kogyo Co., Ltd.), and “Heat Resistive Protease Thermoaze” (trade name, Yamato Kasei Co., Ltd.).

The enzymatic process condition is not specified in particular, provided that a suitable amount of an enzyme or enzymes is added at a pH of the solution being adjusted to one suitable for the enzyme(s) to be used, allowing the enzymes to react at a suitable temperature for them for 0.5 to 24 hours, then devitalizing the enzymes by a heat treatment or the like. The filtrate obtained by filtrating the reaction liquid can be used, directly or properly concentrated into a concentrate, as the virus capturing composition to be used in the present invention. Alternatively, these materials can be freeze-dried or spray-dried.

The average molecular weight of the enzymatically processed material is preferably within a range of 500 to 200,000, more preferably within a range of 2,000 to 70,000.

Other than the water extract or enzymatically-treated substance of swallow nests as described above, the virus capturing composition used in the present invention can include functional food materials, such as saccharides, lactic acid bacteria, bifidus bacteria, polyphenol, oligosaccharide; proteins, aliphatic acids, minerals, vitamins, dietary fibers, sugar alcohols, surfactants, and preservatives.

The form of the virus capturing composition is not critical, but is preferably in a form of solution or jelly. It is also contemplated that the virus capturing composition has highly established safety due to its food-derived ingredients, and therefore it can be used directly for a human body as an inhalation agent.

The content of the water extract of swallow nests and/or the enzymatically-treated substance of swallow nests in the virus capturing composition is preferably in a range of 0.1 to 10,000 μg/mL, and more preferably in a range of 0.2 to 400 μg/mL.

Samples listed in the following Table 1 were prepared and used in the following tests.

TABLE 1

| | | | Sialic | |
|---|---|---|---|---|
| | | | Acid | |
| | | | Content | Protein |
| Sample | Grade | Treatment Method | (Total) | Content |
| 1 | Special | Protease treatment (37° C., 16 | 7.6% by | 64.4% |
| | Grade | hours), followed by heating | weight | by |
| | | (90° C.) devitalization. | | weight |
| | | Filtration, followed by | | |
| | | lyophilization. | | |
| 2 | First | Protease treatment (37° C., 16 | 4.2% by | 67.8% |
| | Grade | hours), followed by heating | weight | by |
| | | (90° C.) devitalization. | | weight |
| | | Filtration, followed by | | |
| | | lyophilization. | | |
| 3 | Second | Boiling after immersion in | 9.6% by | 46.0% |
| | Grade | water, protease treatment | weight | by |
| | | (37° C., 16 hours), followed by | | weight |
| | | heating (90° C.) devitalization. | | |
| | | Filtration, followed by | | |
| | | lyophilization. | | |
| 4 | Special | After grinding, screening | 5.0% by | — |
| | Grade | (150 μm-mesh passing | weight | |
| | | articles). No protease | | |
| | | treatment. | | |
| 5 | Special | After grinding, screening | 9.5% by | — |
| | Grade | (150 μm-mesh passing | weight | |
| | | articles). No protease | | |
| | | treatment. | | |

(1) Infection-Neutralizing Test

Degrees of destruction of the cell membrane due to human influenza viruses were measured by measuring activity of lactic acid dehydorogenase (LDH) released from monolayer cells of an MDCK (Madian-Derby Canine Kidney) infected with influenza viruses (See C-T Guo, C-H Wong, T Kajimoto, T Miura, Y Ida, L R Juneja, M J Kim, H Masusa, T Suzuki, and Y Suzuki. Synthetic sialylphosphatidyl-ethanolamine derivatives bind to human influenza A viruses and inhibit viral infection. Glycoconjugate J., 1998, 15(11): 1099-1108).

Each medium, EMEM (Eagles Minimum Essential Medium), including influenza viruses (A/PR/8134 (H1N1) or A/Aichi/2/68 (H3N2)) of about 100 TCID₅₀ (50% Tissue-Culture Infection Dose) and each sample (ultimate concentration: 1-5000 μg/mL) shown in Table 1 were seeded to monolayer-cultured MDCK cells in a 96-well titer plate (flat bottom), and cultured at 34.5° C. for 5 hours.

After cultured, the liquid portion was removed, and the residue was suspended in 100 μL of the same medium. Further, the suspension was cultured at 34.5° C. for 20 hours, and 12.5 μL of the so-obtained culture medium was diluted four fold with 100 mM Tris hydrochloric acid buffer (pH 8.2), and then 50 μL of an reaction liquid (2 mM NAD, 200 m-unit/mL diaphorase, 190 mM lithium lactate, 0.78 mM nitro bluetetrazolium, 100 mM Tris hydrochloric acid buffer (pH 8.2)) was added. After incubation at 37° C. for 10 minutes, 100 μL of 0.5M hydrochloric acid was added to stop the reaction. The absorbance at 550 nm (control: 630 nm) was measured to obtain LDH activity. Fetuin was used as a positive control. Fetuin is an ingredient contained in fetal bovine serum, and is known to have influenza neutralizing activity. The results are shown in FIG. 10.

As shown in FIGS. 10(A) and 10(B), IC₅₀ for human influenza viruses (A/PR/8/34 (H1N1) and A/Aichi/2/68 (H3N2)) of sample 1 was 80 μg/mL, exhibiting an inhibition activity twice to eight times stronger than that of Fetuin as a positive control. Sample 2 was found to have an inhibition activity for the human influenza virus (A/PR/8/34 (H1N1)), which is substantially the same as Fetuin.

For each sample, an EMEM medium containing a swallow nest solution (initial concentration: 5 mg/mL) diluted twice with MDCK monolayer cells was added to MDCK cells having been monolayer-cultured in the 96-well titer plate (flat bottom), and the admixture was incubated at 37° C. for 25 hours. Investigation for cytotoxicity by measuring the activity of lactic acid dehydorogenase (LDH) in the obtained culture medium showed that the cytotoxicity to the MDCK cells was not exhibited in all of the samples, guaranteeing highly established safety.

(2) Erythrocyte agglutination inhibition test A 25 μL aliquot of PBS was poured into each well of a 96-well titer plate (U-shaped bottom), and 25 μL of test samples (samples 1, 2) were added into the first row of the titer plate, and aspiration and discharge were conducted several times using a micropipette. The 25 μL in the wells of the first row was then transferred to the second row, and aspiration and discharge were conducted several times using a micropipette. This manipulation was further repeated to the third row and then to the forth row to prepare rows diluted twice respectively.

After addition to each well of 25 μL aliquot of solutions containing each virus shown in Table 2, the titer plate was gently shaken, and then allowed to stand at 4° C. for 60 minutes. Subsequently, 50 μL aliquot of 0.5% (v/v) human erythrocyte suspension was added to each well, and the titer plate was gently shaken and allowed to stand at 4° C. for 60 minutes. Thereafter, presence or absence of agglutination was judged from precipitation of the erythrocyte to the bottom of each well, and the minimum concentration capable of causing agglutination inhibition was calculated for each sample. The results are shown in Table 2.

TABLE 2

| | Erythrocyte agglutination inhibition | |
|---|---|---|
| | concentration | |
| | (mg/L) | |
| Virus | Sample 1 | Sample 2 |
| A/PR/8/34 (H1N1) | 2.5 | 40 |
| A/Aichi/2/68 (H3N2) | 20 | 640 |
| A/HongKong/1/68 (H3N2) | 10 | 40 |
| A/Memphis/1/71 (H3N2) | 20 | >2500 |
| A/Memphis/102/72 (H3N2) | 10 | 20 |
| A/Tokyo/6/73 (H3N2) | 5 | 40 |
| A/Kumamoto/55/76 (H3N2) | 20 | 80 |
| A/Texas/1/77 (H3N2) | 5 | 80 |
| A/Yamanashi/2/77 (H3N2) | 2.5 | 40 |
| A/Bangkok/1/79 (H3N2) | 2.5 | 20 |
| A/Duck/Alb/35/76 (H1N1) | 10 | 160 |
| A/Duck/HongKong/7/75 (H3N2) | 1.25 | 20 |
| A/Duck/HongKong/24/76 (H3N2) | 10 | 640 |
| A/Duck/Hokkaido/5/77 (H3N2) | 2.5 | 20 |
| A/Duck/Hokkaido/8/80 (H3N8) | 2.5 | 10 |
| A/Duck/HongKong/23/76 (H5N3) | 1.25 | 20 |
| A/Swine/Iowa/15/30 (H1N1) | 1.25 | 5 |
| A/Swine/Colorado/1/77 (H3N2) | 320 | >2500 |
| A/Swine/HongKong/126/82 | 1.25 | 40 |
| (H3N2) | | |

As shown in Table 2, Sample 1 was found to exhibit erythrocyte inhibition activities at very low concentrations against viruses among the tested influenza viruses (viruses isolated from humans, birds or swine) but for A/Swine/Colorado/1/77 (H3N2). On the other hand, Sample 2 was found to exhibit erythrocyte inhibition activities at significantly low concentrations against viruses except for A/Memphis/1/71 and A/Swine/Colorado/1/77 (H3N2).

From the results, Samples 1, 2 were found to have significant adsorption ability against various types of influenza viruses.

3) Molecular species of sialic acids and their contents contained in Samples 1 and 2

It is apparently known that influenza viruses can recognize particular sugar chains including sialic acids and bind them. The molecular species of sialic acids and their contents in the swallow nest were investigated using the following methods (See Hara, S., Yamaguchi, M., Takemori, Y., Nakamura, M., Ohkura, Y.: Highly sensitive determination of N-acetyl- and N-glycolylneuraminic acid in human serum and urine and rat serum by reverse d-phase liquid chromatography with fluorescence detection. J. Chromatogr., 377, 111-119 (1980), Hara, S., Takemori, Y., Yamaguchi, M., Nakamura, M., Ohkura, Y.: Fluorometric high-performance liquid chromatography of N-acetyl and N-glycolyneuraminic acids and its application to their microdetermination in human and animal sare. Analytical Biochem., 164, 138-145 (1987)).

After hydrolysis of glycoside couplings of sialic acids by heating each samples at 80° C. for 3 hours in a 20 μL and 2M acetic acid solution, 20 μL of a fluorescent reagent was added followed by heating at 50° C. for 2.5 hours.

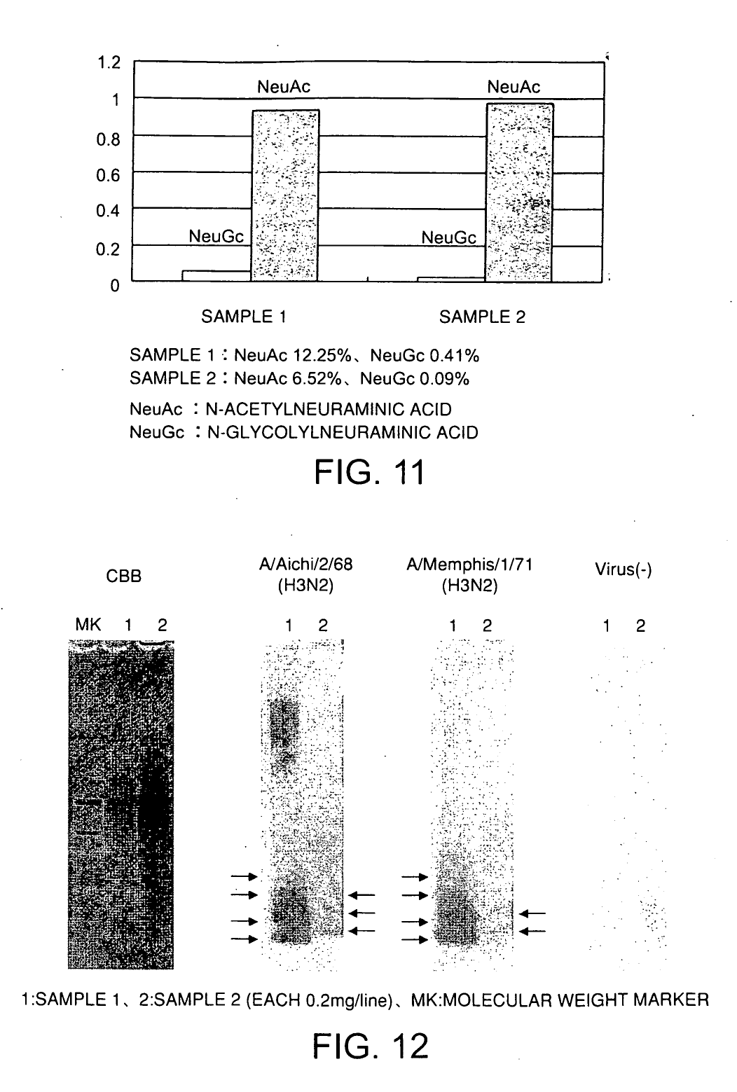

10 μL of the reaction mixture was subjected to HPLC using a COSMOSIL/COSMOGEL Column (trade name, produced by Nakarai Tesk Co., Ltd.) to separate fluorescent derivatives of sialic acids followed by detection using a spectrophotofluorometer (trade name “650-10S”, produced by HITACHI). The results are shown in FIG. 11.

As shown in FIG. 11, any of Sample 1 and Sample 2 was found to contain sialic acids in which N-acetylneuraminic acid (NeuAc) is a major molecular species. Less in the proportion, however, N-glycolylneuraminic acid (NeuGc) is also contained. The content of N-acetylneuraminic acid of Sample 1 (12.25%) is about twice higher than that of Sample 2 (6.52%), and the content of N-glycolylneuraminic acid is 0.41% in Sample 1, while 0.09% in Sample 2.

From these results, the sialic acids contained in Samples 1, 2 are quite similar to the sialic acid molecular species of humans, thus suggesting that proteins, peptides or lipid molecules containing such sialic acids may be ingredients for binding influenza viruses.

Since the fact that Sample 1 was recognized to have a bonding activity and an infection inhibiting activity against influenza viruses higher than those of Sample 2 correlates well with the fact that Sample 1 possesses a sialic-acids content higher than that of Sample 2, it is suggested that the sialic-acids containing molecules in the sample have anti-influenza activities.

(4) Bonding ability of influenza viruses to glycopeptides isolated by the SDS-acrylamide gel electrophoresis (SDS-PAGE) was investigated using the following method (See Takasaki Suzuki, Mikiko Tsukimoto, Masato Kobayashi, Akira yamada, Yoshihiro Kawaoka, Robert G. Webster, Yasuo Suzuki: Sialoglycoproteins that Bind Influenza A Virus and Resist Viral Neuraminidase in Different Animal Sera. J. Gen. Virology, 75, 1769-1774 (1994)).

Sample 1 or Sample 2 dissolved in PBS was diluted with an equivalent amount of a buffer (2% SDS, 10% glycerin, 0.001% Bromphenol Blue, containing 0.0625M Tris buffer, pH 6.8) for preparing specimens used for the SDS-PAGE. Each sample was treated in a hot water bath for 5 minutes, and, under the non-reductive conditions, separation using SDS-polyacrylamide of a 10 to 20% concentration (SDS-PAGE plate: trade name “ET-1020L”, Ato Co., Ltd.) was conducted.

The glycopeptides developed in the gel were transferred to a polyvinylidene difluoride (PVDF) film (produced by Daiichi Kagaku Co., Ltd.) (2 mA/cm current flow for 30 minutes), and blocking was conducted at 4° C. for 15 hours using a 5% bovine serum albumin (BSA)-PBS solution (0.2 mL/cm). Washing the PVDF film with PBS five times, an influenza virus-0.25% BSA-PBS suspension adjusted to 2HAU was added to the film, which was then shaken gently at 4° C. for 15 hours to avoid influence of virus-neuraminidase. Thereafter, the virus suspension was removed, and after washing the PVDF film with PBS five times, anti-influenza antibody was added to the film followed by shaking at 4° C. for 2 hours. Subsequently, the antibody solution was removed, and the PVDF film was washed again with PBS five times, a 0.25% BSA-PBS solution of ABC (peroxidase) kit of VECTASTATIN Kit (trade name, produced by Vector Laboratories, Inc.) was added to the film, which was then shaken at 4° C. for 2 hours. The PVDF film was then washed with PBS five times, and bonding of viruses was investigated using 10 mL of 0.1M acetic acid (pH 6.0) with a coloring liquid (a mixture of 200 μL of an acetonitrile solution of 110 mM 4-chloro-1-naphthol, 200 μL of an acetonitrile solution of 60 mM N,N-diethyl-p-phenylenediamine-dihydrochloride, and 1 μL of a 31% hydroperoxide aqueous solution). The results are shown in FIG. 12.

As shown in FIG. 12, any of Sample 1 and Sample 2 was identified to have bands (bands indicated by arrows in the drawing) bonding influenza viruses (A/Aichi/2/68 (H3N2), A/Memphis/1/71 (H3N2)). On the other hand, since bands bonding viruses could not be identified in a control experiment (Virus (−)) where the viruses were not added but other manipulations were conducted in the same manner as the samples, the identified bands were considered to be glycopeptides which can specifically bind the viruses. Degrees of staining bands by using Coomassie brilliant blue (CBB) (which can stain proteins and peptides) were almost the same in Samples 1, 2, however, in the point of the bonding ability to viruses, Sample 1 is stronger and has more virus types than Sample 2. From these results, it is apparent that Sample 1 contains more abundant glycopeptides than Sample 2, which contain sialic acids capable of bonding influenza viruses.

Since the virus capturing composition of the present invention has highly established safety due to its food-derived ingredients and has adsorption ability to various types of influenza viruses, it can be utilized as an infection preventing agent against viruses. In addition, by directing the virus capturing composition into a mouth of a baby through the nipple 11 of the nipple apparatus 10, virus infection of the baby can be prevented.

1. A nipple apparatus, comprising
a nipple,
a nipple holding member for holding the nipple, and
a cap for engaging with the nipple holding member,
wherein a drug container portion in which a drug is filled and which is covered with a film on the nipple side, is provided in the cap, wherein a cutting portion for cutting the film when the cap engages with the nipple holding member is provided at the nipple holding member, and
wherein a liquid permeating member extending from the cut film of the drug container portion into the nipple is provided at the nipple holding member.

2. The nipple apparatus according to claim 1, wherein the cutting portion comprises a projection for sticking the film.

3. The nipple apparatus according to claim 1, wherein
an external thread is formed in the nipple holding member and an internal thread for engaging with the external thread is formed in the cap.

4. The nipple apparatus according to claim 2, wherein
the liquid permeating member comprises a plate-like member for abutting with the film of the drug container portion and a rod-like member extending from the plate-like member toward the nipple.

5. The nipple apparatus according to claim 4, wherein
an opening is provided in the plate-like member of the liquid permeating member, and the projection projects from the nipple side through the opening toward the drug container portion.

6. The nipple apparatus according to claim 1, wherein
the drug container portion comprises a drug container which is provided in the cap.

7. The nipple apparatus according to claim 1, wherein
the drug container portion comprises an area divided by the film in the cap.

8. The nipple apparatus according to claim 1, wherein
the nipple holding member has a communicating space in communication with the interior of the nipple, the communicating space being covered with a compartment wall which is provided on the side of the drug container portion and has a communicating port.

9. The nipple apparatus according to claim 8, wherein
the cutting portion of the nipple holding member comprises an edge portion of the compartment wall.

10. The nipple apparatus according to claim 8, further comprising,
a one-way valve in the opening of the compartment wall for introducing the drug from the drug container portion to the needle holding member.

11. A nipple apparatus comprising,
a nipple,
a nipple holding member and having a container housing portion communicating with the nipple, for holing the nipple,
a cap attached swayably to the needle holding member and covering the container housing portion, wherein
a drug container in which a drug is filled, having an opening on the side of the nipple is provided in the container housing portion.

12. The nipple apparatus according to claim 11, wherein
a cylindrical guide projecting toward the nipple is provided in the container housing portion, and the drug container has a spout inserted in the cylindrical guide.

13. The nipple apparatus according to claim 12, wherein
the drug container is removable from the container housing portion, and an engagement rib for engaging with the cylindrical guide of the container housing portion is provided in the cap.

14. The nipple apparatus according to claim 12, wherein
the drug container is formed of a flexible material and fixed in the container housing portion, and a pressing portion for crushing the drug container is provided in the cap.

15. The nipple apparatus according to claim 1, wherein
the drug is xylitol.

16. The nipple apparatus according to claim 1, wherein
the drug comprises a virus capturing composition.

17. The nipple apparatus according to any one of claims 16,
wherein
the virus capturing composition contains a water extract of swallow nests and/or an enzymatically-treated substance of swallow nests as an effective ingredient.
